(19) United States
(12) Patent Application Publication
(10) Pub. No.: US 2016/0176302 A1
(43) Pub. Date: Jun. 23, 2016

(54) INTERCONNECTED WIRELESS BATTERY CHARGING AND REGENERATIVE BRAKING SYSTEMS FOR AN ELECTRIC VEHICLE

(71) Applicant: Delphi Technologies, Inc., Troy, MI (US)

(72) Inventors: Richard J. Boyer, Mantua, OH (US); Kerry White Pasha, Cortland, OH (US); Brian D. Pasha, Cortland, OH (US); John Victor Fuzo, Cortland, OH (US)

(21) Appl. No.: 15/046,728

(22) Filed: Feb. 18, 2016

Related U.S. Application Data
(63) Continuation-in-part of application No. 13/562,954, filed on Jul. 31, 2012.
(60) Provisional application No. 61/515,866, filed on Aug. 6, 2011.

(51) Int. Cl. B60L 11/18; B60L 7/10; B60L 3/00

(52) U.S. Cl. CPC B60L 11/182; B60L 11/1861; B60L 3/0046; B60L 7/10

(57) ABSTRACT

A wireless vehicle battery charging system includes an off-vehicle transducer connected to a power source and configured to wirelessly transmit and receive a first alternating current having a first frequency, an on-vehicle transducer configured to wirelessly transmit and receive the first alternating current, and a frequency converting circuit connected to the on-vehicle transducer. The frequency converting circuit is configured to change the first frequency of the first alternating current to a second alternating current having a second frequency. The system further includes a battery within the vehicle and a regenerative braking circuit connected to the frequency converting circuit and the battery. The regenerative braking circuit is configured to rectify the second alternating current to a direct current supplied to the battery and configured to convert the direct current from the battery to the second alternating current supplied to the frequency converting circuit.

### CROSS-REFERENCE TO RELATED APPLICATION

This application is a continuation-in-part application and claims benefit under 35 U.S.C. §120 of U.S. patent application Ser. No. 13/562,954, filed Jul. 31, 2012, which claims priority under 35 U.S.C. §119(e) of U.S. Provisional Patent Application No. 61/515,866, filed Aug. 6, 2011, the entire disclosure of each of which are hereby incorporated herein by reference.

### TECHNICAL FIELD OF THE INVENTION

The invention relates to electric vehicles, in particular to a wireless battery charging system and regenerative braking system that are to reduce the overall number of electrical components in the vehicle and allow two way wireless transmission of electrical power between the electrical vehicle and the utility grid.

### BACKGROUND OF THE INVENTION

The regenerative braking system in an electrical vehicle or hybrid electric vehicle converts direct current from the vehicle's batteries to an alternating current used by the motor/generator to propel the vehicle. The regenerative braking system also converts the alternating electrical current generated by the motor/generator while braking to a direct current that is used to recharge the vehicle's batteries using a rectifier circuit. Thus, some of the vehicle's kinetic energy can be conserved rather than employing friction brakes which convert the vehicle's kinetic energy to waste heat energy. The regenerative braking system is tuned to accommodate alternating current from the motor/generator typically in the 500 Hz to 10 kHz range.

Electrical vehicles have also incorporated wireless battery charging technology that transmits electrical power from an off vehicle battery charger to the vehicle without a direct wired connection between the charger and the vehicle. The battery charger converts electrical power from the utility grid having a frequency of 50 to 60 Hz to a higher frequency of 15 kHz to 150 kHz. The high frequency electrical current is transmitted to an off-vehicle transducer located near the electrical vehicle, e.g. underneath the vehicle, which generates an alternating magnetic field. A receiving coil located in the vehicle is magnetically or inductively coupled with the off-vehicle transducer and the magnetic field induces a high frequency alternating electrical current in the receiving coil. This alternating current is then converted to a direct current that is used to recharge the vehicle's batteries using a rectifier circuit is tuned to accommodate alternating current from receiving coil, typically in the 15 kHz to 150 kHz range.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, a wireless battery charging system is provided. The wireless battery charging system includes an off-vehicle transducer that is electrically connected to a power source and configured to wirelessly transmit and receive a first alternating current having a first frequency, an on-vehicle transducer that is magnetically coupled to the off-vehicle transducer and is configured to wirelessly transmit and receive the first alternating current, and a frequency converting circuit that is disposed within a vehicle and is electrically connected to the on-vehicle transducer. The frequency converting circuit is configured to change the first frequency of the first alternating current to a second alternating current having a second frequency. The first frequency may be in a range of 500 Hz to 10 kHz and the second frequency may be in a range of 15 kHz to 150 kHz. The wireless battery charging system also includes a battery disposed within the vehicle and a regenerative braking circuit that is disposed within the vehicle and is electrically connected to the frequency converting circuit and the battery. The regenerative braking circuit is configured to rectify the second alternating current to a direct current supplied to the battery and is further configured to convert the direct current from the battery to the second alternating current supplied to the frequency converting circuit.

According to one embodiment of the invention, the wireless battery charging system has a first mode of operation in which the on-vehicle transducer wirelessly receives energy from the off-vehicle transducer to produce the first alternating current having the first frequency that is converted by the frequency converting circuit to the second alternating current having the second frequency that is than transmitted through the regenerative braking circuit to electrically charge the battery.

According to another embodiment of the invention, the frequency converting circuit is further configured to change the second frequency of the second alternating current to the first alternating current having the first frequency. In this embodiment, the wireless battery charging system has a second mode of operation in which the battery transmits a direct electrical current through the regenerative braking circuit to supply the second alternating current having the second frequency that is then converted by the frequency converting circuit to the first alternating current having the first frequency which is transmitted through the on-vehicle transducer to wirelessly transmit energy to the off-vehicle transducer, thereby transmitting through the power source to a utility grid.

According to other embodiments of the invention, the first mode of operation or the second mode of operation are selected by the wireless battery charging system. The wireless battery charging system's operation is controlled by user selection of the first mode of operation or the second mode of operation, and a condition selected from the list consisting of:

(a) battery state of charge data,

(b) battery state of health data, and

(c) an on/off state of the wireless battery charging system.

Electrical charging of the battery may be based on user selection of the first mode of operation or the second mode of operation and the conditions listed above. Alternatively, the wireless battery charging system may operate in the first mode of operation or the second mode of operation based on a data received by the wireless battery charging system from a utility grid management facility.

According to another embodiment, the wireless battery charging system further includes an RF data link that is electrically connected to the battery and is configured to wireles sly transmit battery state of charge data and/or battery state of health data to the power source.

### BRIEF DESCRIPTION OF THE SEVERAL VIEWS OF THE DRAWING

The present invention will now be described, by way of example with reference to the accompanying drawings, in which:

FIG. 1 shows a side view of a vehicle and disposition of elements of a wireless battery charging system of in relation therewith in accordance with one embodiment;

FIG. 2 is a schematic diagram of a wireless battery charging system that includes an off-vehicle transducer, an on-vehicle transducer , and the vehicle's regenerative braking circuitry that is used to supply electrical energy to or from a vehicle battery, in accordance with one embodiment; and

FIG. 3 is a schematic diagram of a wireless battery charging system that includes an off-vehicle transducer, an on-vehicle transducer, frequency converting circuitry, and the vehicle's regenerative braking circuitry that is used to supply electrical energy to or from a vehicle battery, in accordance with one embodiment.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While a preferred embodiment has been described, the details may be changed without departing from the invention.

In order to lower the costs of producing and consuming electrical power, it may beneficial to generate and store electrical energy when the demand and/or generating costs are low and retrieve this energy for use when demand and the cost for electrical energy is high. A battery of an electric or hybrid electric vehicle may be utilized for this energy storage. For instance, the battery of the vehicle may be electrically charged during the nighttime hours when energy rates are low and, if the vehicle is not being used and if authorized by the vehicle owner, may be used to provide energy from the stored battery and for use in an energy utility grid when demand for the energy is high during daytime hours. In this scenario, an electrical utility may be able to monetize this energy sharing arrangement with the cooperation of the vehicle owner.

A wireless battery charging system that provides bidirectional energy flow between a utility grid and a battery in a vehicle is presented herein. A regenerative braking system is typically used in an electric vehicle or a hybrid electric vehicle. The regenerative braking system generates an alternating current from the direct current of the vehicle's battery and send the alternating current to the motor/generator to propel the vehicle. The regenerative braking system converts the actuating current from the motor/generator to a direct current that is supplied to the batteries to recapture some of the kinetic energy when the vehicle is braking. The regenerative braking system provides a bidirectional flow of electrical energy to and from the battery. The inventors realized that this bidirectional flow of electrical energy of the regenerative braking system could also be used in conjunction with elements of a wireless charging system. First, the regenerative braking system could rectify the alternating current output by the on-vehicle transducer to a direct current that could be used to charge the battery. This would allow the elimination of a separate rectifier circuit dedicated to the wireless charging system. Second, the regenerative braking system could convert the direct current from the battery to an alternating current that could be transmitted from the on-vehicle transducer to the off-vehicle transducer to provide the battery's stored energy to a power grid. However, since the alternating current used by the motor/generator and regenerative braking system and the alternating current used by the wireless charging system are typically within different frequency ranges, the inventors also realized that the inclusion of a frequency convertor circuit was desired.

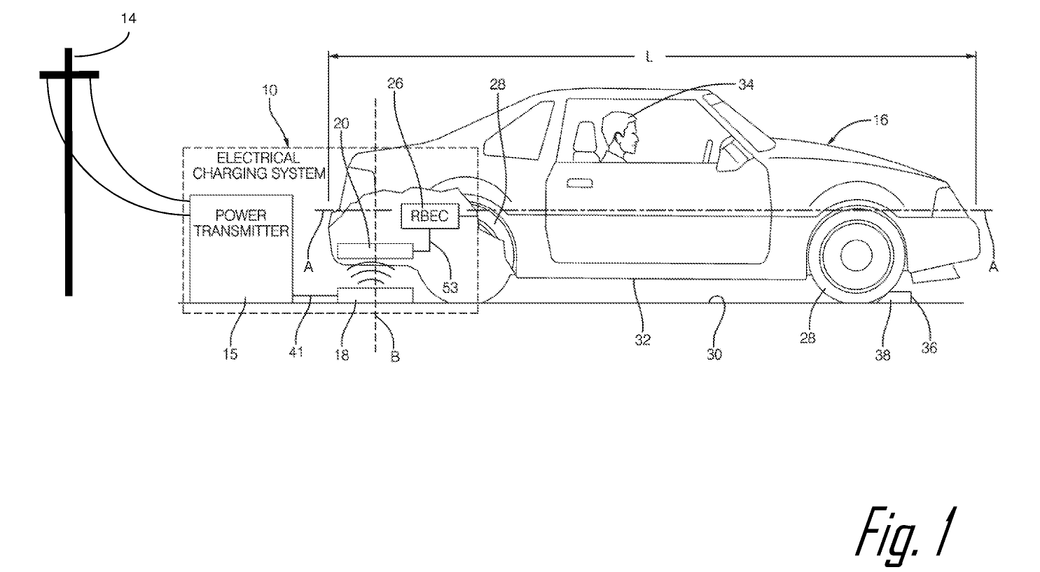

A non-limiting example of a wireless battery charging system 10 is illustrated in FIGS. 1-3.

FIG. 1 illustrates a side view of a vehicle 16 incorporating the wireless battery charging system 10. The power transmitter 15 is connected to an electrical power supply, such as a utility grid 14. The power supply sources an alternating current having a voltage of 110 or 220 volts and a frequency of 50 to 60 Hz. The power transmitter 15 concerts this electrical power to an alternating current having a frequency in the range of 15 kHz to 150 kHz. This higher frequency current is transmitted to an off-vehicle coil 18, hereinafter referred to as an off-vehicle transducer 18 via wiring cable 41. The off-vehicle transducer 18 is located on a ground surface 30, such as driveway or parking lot. A corresponding on-vehicle coil 20 hereinafter referred to as an on-vehicle transducer 20 located on an underside of a vehicle 16. The on-vehicle transducer 20 is electrically connected to regenerative braking circuitry 26 located within the vehicle 16 by wiring cable 53. In order to magnetically couple the off-vehicle transducer 18 and the on-vehicle transducer 20, the user 34 may position the vehicle 16 so that the longitudinal axis A and vertical axis B of the transducers 18, 20 are aligned.

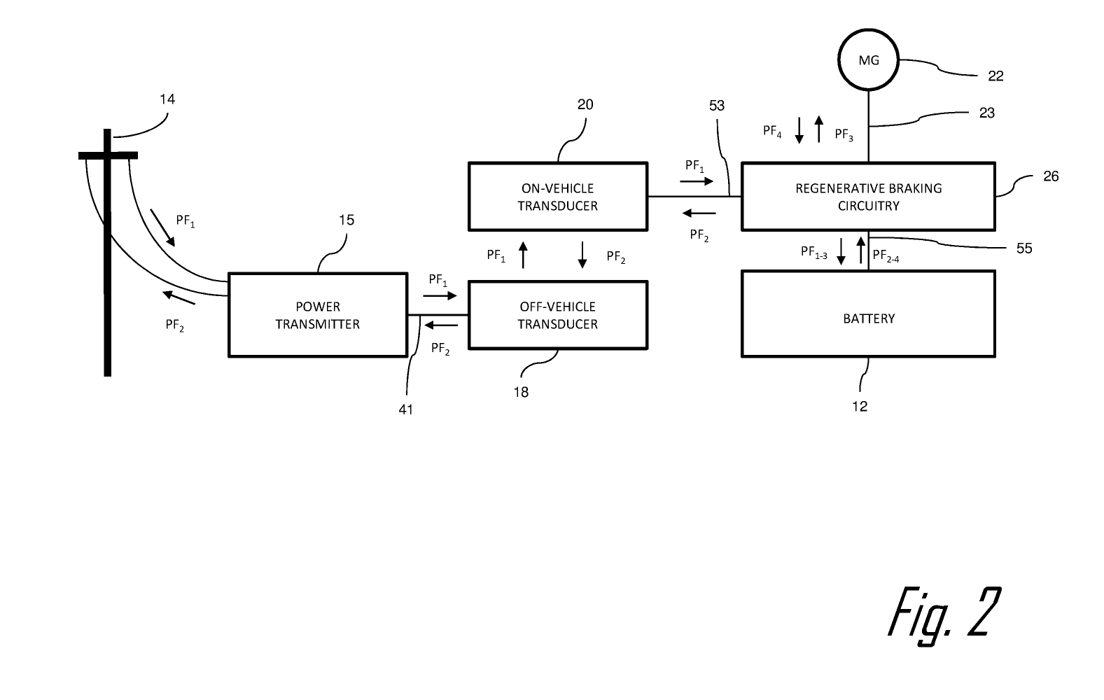

FIG. 2 illustrates a wireless battery charging system 10 configured to wirelessly transfer power to charge a battery 12 from the utility grid 14 and also configured to wirelessly transmit the battery's stored energy back to the utility grid 14. In a first operation mode indicated by power flow PF₁, power in the form of an alternating electrical current flows from the utility grid 14 to the power transmitter 15. This alternating current from the utility grid 14 has a frequency of 50 to 60 Hz. The power transmitter 15 increases the frequency to 15 kHz to 150 kHz. The power transmitter 15 may include a rectifying circuit (not shown) to rectify the 50-60 Hz alternating current to a direct current that is then transmitted to an inverter circuit that containing switching circuits to create the higher frequency alternating current in the 15 kHz to 150 kHz range. The methods and equipment required for this frequency conversion is well known to those skilled in the art. The higher frequency alternating current is then transmitted to the off-vehicle transducer 18 via wiring cable 41. The coils in the off-vehicle transducer 18 generates a magnetic field as the higher frequency alternating current flows through them which induces an alternating current within the on-vehicle transducer 20 having substantially the same frequency. The induced alternating current is transmitted to the regenerative braking circuitry 26 which includes another rectifier circuit to convert the current from the on-vehicle transducer 20 to a direct current that can be used to recharge the battery 12. In a second operation mode indicated by power flow PF₂, power in the form of a direct current flow from the battery 12 is transmitted to the regenerative braking circuitry 26. The regenerative braking circuitry 26 includes another inverter circuit that converts the direct current from the battery 12 to a high frequency alternating current in the 15 kHz to 150 kHz range. The high frequency alternating current is transmitted to the on-vehicle transducer 20 which generates a magnetic field as the high frequency alternating current flows through the coils of the on-vehicle transducer 20 which induces an alternating current within the off-vehicle transducer 18, again having substantially the same frequency. The induces alternating current is then transmitted to the power transmitter 15 where the rectifier circuit converts the high frequency induced current tot a direct current and the inverter circuit in the power transmitter 15 converts the direct current to an alternating current in the 50-60 Hz range that is transmitted back to the utility grid 14.

A third power flow PF₃ is shown in FIG. 2 which represents the supply of electrical power from the battery 12 to the motor/generator 22 to propel the vehicle 16. In this mode of vehicle operation, direct current from the battery 12 is supplied to the regenerative braking circuitry 26 via cable 55. The inverter circuit in the regenerative braking circuitry 26 converts the direct current to an alternating current, typicality in a range from 500 Hz to 10 kHz, that is supplied to the motor/generator 22 via wiring cable 23. A fourth power flow PF₄ illustrates generation of alternating current by the motor/generator 22 in braking conditions. This alternating current is transmitted to the regenerative braking circuitry 26 wherein the rectified circuit converts the alternating current to a direct current that is transmitted to the battery 12 to recharge the battery 12.

The wireless battery charging system 10 presented in FIG. 2 assumes that the inverter circuit and rectifier circuit of the regenerative braking system are adaptable to operate in two different frequency ranges for example in a 500 Hz to 10 kHz range for operation with the motor generator and in a 15 kHz to 150 kHz range in order to operate with the on-vehicle transducer 20.

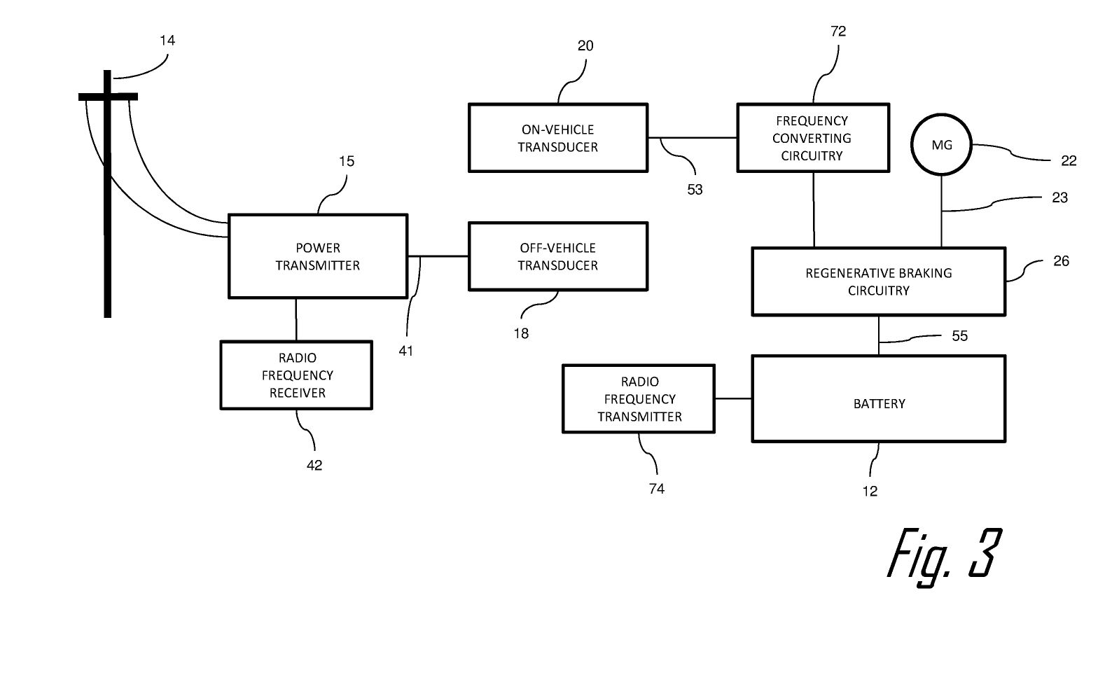

In order to take advantage of existing regenerative braking circuitry 26 that is configured to operating within a single frequency range of 500 Hz to 10 kHz, an embodiment may desired that includes a separate frequency converting circuit 72 as shown in FIG. 3 that is configured to convert an alternating current from the regenerative braking circuitry 26 in the 500 Hz to 10 kHz range usable by the motor generator to an alternating current in the 15 kHz to 150 kHz usable by the on-vehicle transducer 20. The frequency converting circuit 72 is also configured to convert an alternating current in the 15 kHz to 150 kHz from the on-vehicle transducer 20 to an alternating current in the 500 Hz to 10 kHz range usable by regenerative braking circuitry 26. The frequency converting circuit 72 may include one rectifier-inverter circuit combination to convert the lower frequency alternating to higher frequency alternating current and a second rectifier-inverter circuit combination to convert the higher frequency alternating to lower frequency alternating current. Alternatively, the frequency converting circuit 72 may include a single rectifier-inverter circuit combination wherein the rectifier and inverter are capable of operation in both frequency ranges and switching circuitry to properly configure inputs and outputs of the frequency converting circuit 72.

As further illustrated in FIG. 3, the wireless battery charging system 10 may include a radio frequency (RF) transmitter 74. The RF transmitter 74 is electrically connected to the battery 12 and wirelessly transmits data to the radio frequency (RF) receiver 42. The RF transmitter 74 collects data about the operational characteristics of the wireless battery charging system 10 and battery 12. These characteristics includes battery voltage system (V), a battery state of health (SoH), and battery state of charge (SoC), and the ON/OFF state of the wireless battery charging system 10. RF transmitter 74 wirelessly communicates this data information via a wireless signal to the RF receiver 42 connected to the power transmitter 15 so that the charging system efficiency is maintained at a desired rate to electrically charge the battery 12. In alternative embodiments, the RF receiver 42 and the RF transmitter 74 may both be RF transceivers to allow two way data communication between the on-vehicle and off-vehicle portions of the wireless battery charging system 10.

A data message sent from a utility grid facility (not shown) may command the wireless battery charging system 10 to operate in the second mode of operation wherein energy is transferred from the battery 12 to the utility grid 14. The wireless battery charging system 10 may be configured to allow the user 34 to inhibit the second mode of operation to occur, for example if the user 34 has a trip with the vehicle 16 planned in the near future. The operator or user 34 may make user-selectable mode selections for the wireless battery charging system 10 by cellular phone, PDA, personal computer, and the like.

The wireless battery charging system 10 presented herein provides using regenerative braking circuitry 26 on the vehicle 16 for both regenerative braking when the vehicle 16 is being driven and wireless charging when the vehicle 16 is stationary. This provides cost and packaging benefits for the vehicle 16 since there is no need for a separate rectifier dedicated to the wireless changing system since the rectifier can be shared for both braking and charging. The system also provides the benefits of storing and supplying power to a utility grid 14 from the vehicle's battery 12. This the benefits of generating and storing electrical energy when the demand and/or generating costs are low and retrieve this energy for use when demand and the cost for electrical energy is high. In this scenario, an electrical utility may be able to monetize this energy sharing arrangement with the cooperation of the vehicle owner. The system also provides benefits since the vehicle's inverter can be used both for powering the motor/generator 22 and providing power to the utility grid 14 without the need for additional circuitry being added to the vehicle, again saving component cost, vehicle packaging space, and vehicle mass.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A wireless battery charging system, comprising:
an off-vehicle transducer electrically connected to a power source and configured to wirelessly transmit and receive a first alternating current having a first frequency;
an on-vehicle transducer configured to wirelessly transmit and receive the first alternating current;
a frequency converting circuit disposed within a vehicle and electrically connected to the on-vehicle transducer, wherein the frequency converting circuit is configured to change the first frequency of the first alternating current to a second alternating current having a second frequency;
a battery disposed within the vehicle; and
a regenerative braking circuit disposed within the vehicle and electrically connected to the frequency converting circuit and the battery, wherein the regenerative braking circuit is configured to rectify the second alternating current to a direct current supplied to the battery and configured to convert the direct current from the battery to the second alternating current supplied to the frequency converting circuit.

2. The system according to claim 1, wherein the wireless battery charging system has a first mode of operation whereby the on-vehicle transducer wirelessly receives energy from the off-vehicle transducer to produce the first alternating current having the first frequency that is converted by the frequency converting circuit to the second alternating current having the second frequency that is than transmitted through the regenerative braking circuit to electrically charge the battery.

3. The system according to claim 2, wherein the wherein the frequency converting circuit is further configured to change the second frequency of the second alternating current to the first alternating current having the first frequency and wherein the wireless battery charging system has a second mode of operation whereby the battery transmits a direct electrical current through the regenerative braking circuit to supply the second alternating current having the second frequency that is converted by the frequency converting circuit to the first alternating current having the first frequency which is transmitted through the on-vehicle transducer to wirelessly transmit energy to the off-vehicle transducer, thereby transmitting through the power source to a utility grid.

4. The system according to claim 3, wherein the first mode of operation or the second mode of operation are selected by the wireless battery charging system.

5. The system according to claim 3, wherein the wireless battery charging system's operation is controlled by user selection of the first mode of operation or the second mode of operation, and a condition selected from the list consisting of:
(a) battery state of charge data,
(b) battery state of health data, and
(c) an on/off state of the wireless battery charging system.

6. The system according to claim 3, wherein electrical charging of the battery is based on user selection of the first mode of operation or the second mode of operation, and
(a) battery state of charge data, and
(c) battery state of health data, and
(c) an on/off state of the wireless battery charging system.

7. The system according to claim 3, wherein the wireless battery charging system operates in the first mode of operation or the second mode of operation based on a data received by the wireless battery charging system from a utility grid management facility.

8. The system according to claim 1, further comprising an RF data link electrically connected to the battery and configured to wirelessly transmit battery state of charge data to the power source.

9. The system according to claim 8, wherein the RF data link is configured to wireles sly transmit a battery state of health data to the power source.

10. The system according to claim 1, wherein the first frequency is in a range of 500 Hz to 10 kHz and the second frequency is in a range of 15 kHz to 150 kHz.
